(19) United States
(12) Patent Application Publication
(10) Pub. No.: US 2014/0262195 A1
(43) Pub. Date: Sep. 18, 2014

(54) SYSTEM AND METHOD FOR CONTROLLING FLOW RATE OF COOLANT OF GREEN CAR

(71) Applicant: HYUNDAI MOTOR COMPANY, Seoul (KR)

(72) Inventor: Jinhun LEE, Uijeongbu-si (KR)

(73) Assignee: HYUNDAI MOTOR COMPANY, Seoul (KR)

(21) Appl. No.: 14/103,813

(22) Filed: Dec. 11, 2013

(30) Foreign Application Priority Data
Mar. 13, 2013 (KR) 10-2013-0026670

(51) Int. Cl. B60H 1/00

(52) U.S. Cl. CPC B60H 1/00764
USPC 165/200

(57) ABSTRACT

A system and a method for controlling the flow rate of a coolant can efficiently cool cooling targets, such as motor, inverter, converter, etc., which are electric and electronic devices requiring to be cooled by water, by estimating an increase in temperature on the basis of traveling conditions of a vehicle and by increasing the flow rate of the coolant. A method of cooling electric and electronic devices in an environmentally-friendly vehicle may include determining whether driving torque or driving torque instruction value is a predetermined value or higher, determining whether regenerative braking torque is a predetermined value or higher, and increasing the flow rate of the coolant by driving a pump when the driving torque, the driving torque instruction value, or the regenerative braking torque is the corresponding predetermined value or higher.

### CROSS-REFERENCE TO RELATED APPLICATION

This application claims priority to and the benefit of Korean Patent Application No. 10-2013-0026670 filed in the Korean Intellectual Property Office on Mar. 13, 2013, the entire contents of which are incorporated herein by reference.

### TECHNICAL FIELD

The present disclosure relates to a system and a method for controlling a coolant flow rate in an environmentally-friendly vehicle, and more particularly, to a system and a method for controlling flow rate of a coolant having advantages of being able to efficiently cool a cooling target by estimating an increase in temperature of cooling targets, such as a motor, inverter, converter, etc. in a fuel cell vehicle, an electric vehicle, a plug-in electric vehicle, and a hybrid vehicle.

### BACKGROUND

As well known in the art, environmentally-friendly vehicles have been provided in accordance with a demand for improvement of fuel efficiency and the enhanced regulations of on board diagnosis (OBD) for exhaust gases.

The environmentally-friendly vehicles, such as a fuel cell vehicle, an electric vehicle, a plug-in electric vehicle, and a hybrid vehicle, include an electric motor and an internal combustion engine equipped with a battery to store high-voltage power for driving the motor and an inverter to convert DC voltage of the battery into AC voltage.

Environmentally-friendly vehicles include various electric and electronic devices, such as a motor, an inverter, and a converter which require an appropriate water cooling system.

FIG. 1 schematically shows a common water-cooled cooling system for electric and electronic devices used in environmentally-friendly vehicles.

Referring to FIG. 1, a controller 10 checks the temperature of a cooling target 20 by means of a temperature sensor 22 detecting temperature. The cooling target 20 may include a motor, an inverter, a converter, etc.

When the detected temperature of the cooling target 20 is a predetermined temperature or higher, the controller 10 increases the flow rate of a coolant passing through a radiator 30 by controlling a pump 40 to decrease the temperature of the cooling target 20. The flow rate of the coolant is increased by increasing the number of revolutions of the pump 30.

The controller 10 maintains the temperature of the coolant flowing into the cooling target 20 at a predetermined temperature or lower by performing feedback control on the pump 40 on the basis of the coolant temperature detected by a coolant temperature sensor 52.

Referring to FIG. 2, for the temperature of the cooling target 20 with the predetermined temperature or higher, an area ST, where the temperature of the cooling target 20 is at or above the predetermined temperature, may appear causing a decrease in durability, reliability, etc. of the cooling target 20.

The above information disclosed in the Background section is only for enhancement of understanding of the background of the disclosure, and therefore, it may contain information that does not form the prior art already known in this country to a person of ordinary skill in the art.

### SUMMARY

The present disclosure provides a system and a method for controlling the flow rate of a coolant having advantages of being able to efficiently cool cooling targets including a motor, an inverter, a converter, etc., by estimating an increase in temperature, which require water cooling, on the basis of the traveling conditions of a vehicle and by increasing the flow rate of a coolant.

According to an exemplary embodiment of the present disclosure, a method of cooling electric and electronic devices that are cooling targets in an environmentally-friendly vehicle may include: determining whether driving torque or a driving torque instruction value is at a predetermined value or higher; determining whether regenerative braking torque is at a predetermined value or higher; and increasing the flow rate of a coolant by driving a pump when the driving torque, the driving torque instruction value, or the regenerative braking torque is at the corresponding predetermined value or higher.

The factor for determining an increase in the driving torque or the driving torque instruction value may include a slope angle, amount of overload, and the rate of change in vehicle speed.

The method of controlling the flow rate of a coolant in an environmentally-friendly vehicle may further include increasing the flow rate of the coolant by driving the pump when the voltage of a 12V battery of the environmentally-friendly vehicle is at a predetermined value or lower.

The method of controlling the flow rate of a coolant in an environmentally-friendly vehicle may further include increasing the flow rate of the coolant by driving the pump when the value obtained by subtracting external air temperature, which is detected by an external air temperature sensor, from coolant temperature, which is detected by a coolant temperature sensor, is at a predetermined value or higher.

The method of controlling the flow rate of a coolant in an environmentally-friendly vehicle may further include increasing the flow rate of the coolant by driving the pump when the value obtained by subtracting the coolant temperature, which is detected by the coolant temperature sensor, from the temperature of the cooling target is at a predetermined value or lower.

According to another exemplary embodiment of the present disclosure, a system for controlling flow rate of a coolant in an environmentally-friendly vehicle to cool electric and electronic devices that are cooling targets may include a coolant temperature detector detecting coolant temperature, and a cooling target temperature detector detecting the temperature of a cooling target. An inclination angle detector is disposed to detect a slope angle, and a vehicle speed detector is disposed to detect a vehicle speed. A torque calculator calculates driving torque or a driving torque instruction value and regenerative torque. A pump is installed to adjust the flow rate of the coolant by pumping the coolant passing through a radiator, and a controller adjusts the flow rate of the coolant by controlling the pump on the basis of signals from the detectors, in which the controller may be operated by a program set to perform the method of controlling the flow rate of a coolant.

As described above, cooling targets, such as motor, inverter, converter, etc. which are electric and electronic devices requiring to be cooled by water can be efficiently cooled, by estimating an increase in temperature of the cooling targets on the basis of traveling conditions of a vehicle and by increasing the flow rate of the coolant.

### BRIEF DESCRIPTION OF THE DRAWINGS

FIG. 1 is a block diagram schematically showing a common water-cooled cooling system for electric and electronic devices.

FIG. 2 is a graph illustrating the operations of the related art and an exemplary embodiment of the present disclosure.

FIG. 3 is a schematic diagram of a system for controlling the flow rate of a coolant in an environmentally-friendly vehicle according to an exemplary embodiment of the present disclosure.

FIG. 4 is a flowchart illustrating a method of controlling the flow rate of a coolant in an environmentally-friendly vehicle according to an exemplary embodiment of the present disclosure.

### DETAILED DESCRIPTION

Hereinafter, the present disclosure will be described more fully with reference to the accompanying drawings. However, the present disclosure is not limited to the exemplary embodiments described herein and may be embodied in other ways.

Throughout the present specification, unless explicitly described otherwise, “including” any components will be understood to imply the inclusion of other components rather than the exclusion of any other components.

FIG. 3 is a schematic diagram of a system for controlling the flow rate of a coolant in an environmentally-friendly vehicle according to an exemplary embodiment of the present disclosure.

As shown in FIG. 3, a system for controlling the flow rate of a coolant includes a coolant temperature detector 152 disposed in a pipe 150 and detecting coolant temperature, and a cooling target temperature detector 122 disposed on a corresponding cooling target 120, such as a motor, an inverter, and a converter and detecting the temperature of the cooling target 120. An inclination angle sensor 230 is installed to detect an inclination angle, a vehicle speed sensor 210 detects a vehicle speed, and an acceleration sensor 220 detects acceleration of a vehicle. A torque calculator 240 calculates driving torque or a driving torque instruction value and regenerative braking torque, and a pump 140 is disposed to adjust the flow rate of a coolant by pumping the coolant passing through a radiator 130. A controller 200 adjusts the flow rate of the coolant by controlling the pump 140 on the basis of signals from the detectors.

The coolant temperature detector 152 may be a temperature sensor detecting coolant temperature but is not limited thereto. The spirit of the present disclosure can be applied to other configurations that actually detect the temperature of a coolant, even if they are different configurations.

Referring to FIG. 3, the coolant temperature detector 152 is disposed in the pipe 150 connecting the radiator 130 with the cooling target 120. The coolant temperature detector 152 may be disposed in a pipe connecting the radiator 130 with the pump 140 or a pipe connecting the cooling target 120 with the pump 140, depending on the configuration of the system for controlling the flow rate of a coolant in an environmentally-friendly vehicle or the circulation direction of the coolant.

The cooling target temperature detector 122 may be a temperature sensor detecting temperature of a cooling target, but is not limited thereto. The spirit of the present disclosure can be applied to other configurations that actually detect the temperature of a cooling target, even if they have different configurations.

The vehicle speed sensor 210, the acceleration sensor 220, and the inclination angle sensor 230 may be sensors that are used at present in environmentally-friendly vehicles or common vehicles.

The torque calculator 240 may be a calculator that calculates torque generated or to be generated by an engine 2 and/or a motor 4. The calculator may include an engine controller controlling the engine 2, a motor controller controlling the motor 4, and a hybrid controller controlling the entire operation of a hybrid vehicle.

The pump 140 may be a pump that is used for pumping a coolant in environmentally-friendly vehicles or common vehicles.

The controller 200 is one or more microprocessors operated by a predetermined program or hardware including the microprocessors. The predetermined program may be composed of a series of instructions for performing a method of controlling the flow rate of a coolant, which is described below.

Hereinafter, a method of controlling the flow rate of a coolant in an environmentally-friendly vehicle according to an exemplary embodiment of the present disclosure is described in detail with reference to the accompanying drawings.

FIG. 4 is a flowchart illustrating a method of controlling the flow rate of a coolant in an environmentally-friendly vehicle according to an exemplary embodiment of the present disclosure.

The method of controlling the flow rate of a coolant in an environmentally-friendly vehicle minimizes an increase in temperature of a corresponding cooling target by estimating the time, when the temperature increase is estimated on the basis of the traveling conditions of a vehicle, and by increasing the flow rate of a coolant at the time, when the temperature increase is estimated.

Referring to FIG. 4, the controller 200 checks how much the current driving torque or the driving torque instruction value calculated by the torque calculator 240 is, or how much the driving torque or the driving torque instruction value to be outputted in accordance with requested torque by a driver is (S100).

The driving torque or the driving torque instruction value increases during acceleration traveling, slope traveling, or overload traveling. When the driving torque or the driving torque instruction value increases, current increases in proportion to an increase of the driving torque or the driving torque instruction value in a corresponding electric and electronic device, such as a motor, an inverter, a converter, etc., and the temperature of the cooling target 120 increases. That is, when a large amount of current is consumed by the cooling target 120, temperature of the cooling target 120 is increased in proportion to the current consumption.

The controller 200 determines whether the checked driving torque or driving torque instruction value is at a predetermined value or higher (S200) to consider traveling conditions. The predetermined value may simply be set to a value where the temperature of the cooling target 120 increases to which cooling is required, determined by current consumption corresponding to the driving torque or the driving torque instruction value.

When the driving torque or the driving torque instruction is at the corresponding predetermined value or higher in S200, the controller 200 increases the flow rate of the coolant by controlling the pump 140 to minimize the temperature increase of the cooling target 120 (S300).

Referring to FIG. 2, when driving torque or a driving torque instruction value, due to acceleration, increases to the corresponding predetermined value or higher, the controller 200 estimates the increase in temperature of the cooling target 120 and increases the flow rate of the coolant by controlling the operation of the pump 140, thus minimizing the increase in temperature of the cooling target 120.

When the driving torque or the driving torque instruction value is less than the predetermined value in S200, the temperature increased by the cooling target 120 increases the flow rate of the coolant. The cooling target 120 then does not need to be cooled, and the controller 200 does not increase the flow rate of the coolant through the pump 140.

Further, when the driving torque or the driving torque instruction value is less than the predetermined value in S200, the controller 200 determines whether regenerative braking is performed in the vehicle on the basis of signals from the vehicle speed sensor 210, the acceleration sensor 220, the inclination angle sensor 230, and the brake sensor (S400).

It would be apparent to those skilled in the art that the regenerative braking is performed during a downward travelling or rapid stopping.

Regenerative braking is performed since current is generated and flows by regenerative braking. The temperature of the corresponding cooling target 120 correspondingly increases in regenerative braking. Therefore, the controller 200 determines whether regenerative braking torque calculated by the torque calculator 240 is a corresponding predetermined value or higher (S500).

When regenerative braking torque is at the corresponding predetermined value or higher in S500, the controller 200 increases the flow rate of the coolant by controlling the pump 140 to minimize the temperature increase of the cooling target 120 (S300).

On the other hand, when the regenerative braking torque is less than the corresponding predetermined value in S500, the controller 200 checks other traveling conditions that may increase the temperature of the cooling target 120.

The controller 200 determines whether the voltage of a 12V battery, which is a low-voltage battery of environmentally-friendly vehicles, is at a corresponding predetermined value or lower (S600).

The voltage is checked in S600 since current increases in a low voltage DC-DC converter (LDC) to charge the battery when the voltage of the 12V battery is at a corresponding predetermined value or lower, where the LDC is included in the cooling target 120.

When the voltage of the 12V battery is a corresponding predetermined value or lower in S600, the controller 200 increases the flow rate of the coolant by controlling the pump 140 to minimize the increase in temperature of the cooling target 120 (S300).

On the other hand, when the voltage of the 12V battery is higher than a corresponding predetermined value in S600, the controller 200 determines whether the value obtained by subtracting the external air temperature from the coolant temperature is at a corresponding predetermined value or higher (S700).

The value obtained by subtracting the external air temperature from the coolant temperature is larger than the corresponding predetermined value since the temperature of the coolant is increased by heat generated by the cooling target 120, such that the flow rate of the coolant need not to be increased.

The controller 200 increases the flow rate of the coolant by controlling the operation of the pump 140 to sufficiently cool the cooling target 120 when the value obtained by subtracting the external air temperature from the coolant temperature is at a corresponding predetermined value or higher in S700 (S300).

However, when the value obtained by subtracting the external air temperature from the coolant temperature is less than the corresponding predetermined value in S700, the controller 200 determines whether the value obtained by subtracting the coolant temperature from the temperature of the cooling target 120 is at a corresponding predetermined value or less (S800).

The value obtained by subtracting the coolant temperature from the temperature of the cooling target 120 having the corresponding predetermined value or lower means that the cooling target 120 has not been efficiently cooled by the coolant. Therefore, the flow rate of the coolant is increased to sufficiently cool the cooling target 120.

The controller 200 increases the flow rate of the coolant by controlling the operation of the pump 140 to sufficiently cool the cooling target 120 when the value obtained by subtracting the coolant temperature from the temperature of the cooling target 120 is at a corresponding predetermined value or lower in S800 (S300).

As a result, the temperature increase of cooling targets can be efficiently prevented by determining traveling conditions of a vehicle, estimating the time when electric and electronic devices which are the cooling targets increase in temperature, and increasing the flow rate of a coolant when the temperature increase is estimated.

While the disclosure has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A method of cooling electric and electronic devices that are cooling targets in an environmentally-friendly vehicle, the method comprising:
determining whether a driving torque or a driving torque instruction value is a predetermined value or higher;
determining whether a regenerative braking torque is a predetermined value or higher; and
increasing a flow rate of a coolant by driving a pump, when the driving torque, the driving torque instruction value, or the regenerative braking torque is the corresponding predetermined value or more.

2. The method of claim 1, wherein the factor for determining an increase in the driving torque or the driving torque instruction value includes a slope angle, amount of overload, and a rate of change in a vehicle speed.

3. The method of claim 1, further comprising increasing the flow rate of the coolant by driving the pump, when a voltage of a battery of the environmentally-friendly vehicle is a predetermined value or lower.

4. The method of claim 1, further comprising increasing the flow rate of the coolant by driving the pump, when the value obtained by subtracting external air temperature detected by an external air temperature sensor from coolant temperature detected by a coolant temperature sensor is a predetermined value or higher.

5. The method of claim 1, further comprising increasing the flow rate of the coolant by driving the pump, when the value obtained by subtracting coolant temperature detected by a coolant temperature sensor from temperature of the cooling target is a predetermined value or lower.

6. A system for cooling electric and electronic devices that are cooling targets in an environmentally-friendly vehicle, the system comprising:
a coolant temperature detector that detects coolant temperature;
a cooling target temperature detector that detects the temperature of the cooling target;
an inclination angle detector that detects a slope angle;
a vehicle speed detector that detects a vehicle speed;
a torque calculator that calculates a driving torque or a driving torque instruction value and a regenerative torque;
a pump that adjusts a flow rate of a coolant by pumping the coolant passing through a radiator; and
a controller that adjusts the flow rate of the coolant by controlling the pump on the basis of signals from the detectors,
wherein the controller is operated by a program set to perform a method including: determining whether the driving torque or the driving torque instruction value is a predetermined value or higher; and increasing the flow rate of the coolant by driving the pump, when the driving torque, the driving torque instruction value, or the regenerative braking torque is—the corresponding predetermined value or higher.

7. The system of claim 6, wherein a factor for determining an increase in the driving torque or the driving torque instruction value includes a slope angle, amount of overload, and a rate of change in a vehicle speed.

8. The system of claim 6, wherein
the controller is operated by a program set to perform a method including:
increasing the flow rate of the coolant by driving the pump, when a voltage of a 12V battery of the environmentally-friendly vehicle is at a predetermined value or lower;
increasing the flow rate of the coolant by driving the pump, when the value obtained by subtracting external air temperature detected by an external air temperature sensor from coolant temperature detected by a coolant temperature sensor is at a predetermined value or higher; and
increasing the flow rate of the coolant by driving the pump, when the value obtained by subtracting the coolant temperature detected by the coolant temperature sensor from the temperature of the cooling target is at a predetermined value or lower.
